(19) United States
(12) Patent Application Publication
(10) Pub. No.: US 2012/0314020 A1
(43) Pub. Date: Dec. 13, 2012

(54) MOVE-IT: MONITORING, OPERATING, VISUALIZING, EDITING INTEGRATION TOOLKIT FOR RECONFIGURABLE PHYSICAL COMPUTING

(75) Inventor: Victor Ng-Thow-Hing, Sunnyvale, CA (US)

(73) Assignee: HONDA MOTOR CO,, LTD., Tokyo (JP)

(21) Appl. No.: 13/461,598

(22) Filed: May 1, 2012

Related U.S. Application Data
(60) Provisional application No. 61/496,458, filed on Jun. 13, 2011.

(51) Int. Cl. H04N 5/225; G06F 3/048

(52) U.S. Cl. 348/36; 715/799; 901/50; 348/E05.024

(57) ABSTRACT

A user interface screen for displaying data associated with operation of a robot where the user interface screen includes one or more windows that can be rotated and then minimized into an icon to render space for other windows. As user input for moving a window is received, the window moves to an edge. As further user input is received, the window is rotated about an axis and then minimized into an icon. In this way, the windows presented on the screen can be intuitively operated by a user.

### CROSS-REFERENCE TO RELATED APPLICATIONS

This application claims priority under 35 U.S.C. §119(e) to co-pending U.S. Provisional Patent Application No. 61/496,458 entitled “MOVE-IT: Monitoring, Operating, Visualizing, Editing Integration Toolkit for Reconfigurable Physical Computing,” filed on Jun. 13, 2011, which is incorporated by reference herein in its entirety.

### FIELD OF THE INVENTION

The present invention is related to a user interface for displaying information on a computing device.

### BACKGROUND OF THE INVENTION

Various data is collected and processed during the operation of computing devices such as desktop computers, laptop computers, on-board telematics devices in cars, mobile devices (e.g., smartphones) and consoles. In many of these devices, the information is presented to users in the form of windows that are displayed on a defined area of a display device. During the operation of the computing devices, certain windows may be enlarged, reduced in size or moved to facilitate the users' operations.

Taking an example of a computing device associated with controlling or monitoring operation of a robot, various data associated with the operation or control of the robot may be displayed on a display device. The various data displayed may include, for example, signals from sensors, angles of one or more joints, location of objects surrounding the robot, remaining computing or storage resources on the robot. Such data may be transmitted from the robot to a computing device located remotely from the robot where a user may view and take actions as needed.

In many cases, a single window allows a user to view certain information and perform predefined functions on the computing device. Hence, to view different information or perform different functions on the computing device, additional windows may need to be launched or activated on the computing device. For this and other reasons, users often launch multiple windows on display devices.

When the display device is cluttered with too many windows, however, the user may have a difficult time identifying and tracking information relevant to the user. To reduce cluttering of windows in the display device, the user may close or reduce the size of windows displaying less important information to focus on more windows that display more important information. However, the closing or reducing the size of window may involve user actions that are neither intuitive nor convenient.

### SUMMARY OF THE INVENTION

Embodiments relate to displaying data on a screen where a window is reduced in size by rotation in response to receiving user input to make space for other windows on the screen. Data processed at a computing device is displayed within an area of the screen defined by the window. The window is moved to a predefined region of the screen after receiving first user input. The window is rotated about an axis in response to receiving second user input after the window reaches the predefined region of the screen. The size of the window is reduced by the rotation of the window.

In one embodiment, the window is reduced into an icon in response to receiving third user input after the window is rotated to a predetermined angle.

In one embodiment, the first user input, the second user input and the third user input are caused by dragging a user input device in the same direction.

In one embodiment, the predefined region of the screen includes edge regions of the screen.

In one embodiment, the displayed data includes data associated with the operation of a robot.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the present disclosure can be readily understood by considering the following detailed description in conjunction with the accompanying drawings.

FIG. 1 is a schematic diagram of a robot and a remote computer communicating with the robot, according to one embodiment.

FIG. 2 is a block diagram of the remote computer, according to one embodiment.

FIG. 3 is a block diagram of software components stored in the memory of the remote computer, according to one embodiment.

FIGS. 4A through 4C are diagrams illustrating transition of a fold-away window on a screen responsive to receiving a user input moving the window to the left edge of the screen, according to one embodiment.

FIGS. 5A through 5C are diagrams illustrating transition of a fold-away window on a screen responsive to receiving a user input moving the window to the bottom edge of the screen, according to one embodiment.

FIG. 6 is a flowchart illustrating a process of reducing the size of a window, according to one embodiment.

### DETAILED DESCRIPTION OF THE DISCLOSURE

A preferred embodiment is now described with reference to the figures where like reference numbers indicate identical or functionally similar elements.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions could be embodied in software, firmware or hardware, and when embodied in software, could be downloaded to reside on and be operated from different platforms used by a variety of operating systems.

Embodiments also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the embodiments are not described with reference to any particular programming language. It will be appreciated that a variety of programming languages may be used to implement the teachings as described herein, and any references below to specific languages are provided for disclosure of enablement and best mode.

In addition, the language used in the specification has been principally selected for readability and instructional purposes, and may not have been selected to delineate or circumscribe the inventive subject matter. Accordingly, the disclosure is intended to be illustrative, but not limiting, of the scope, which is set forth in the following claims.

Embodiments relate to providing a user interface screen for displaying data associated with processing at a computing device where the user interface screen includes one or more windows that can be rotated and then minimized into an icon to render space for other windows. As user input for moving a window is received, the window moves to an edge area of the screen. As further user input is received, the window is rotated about an axis and then minimized into an icon. In this way, the windows presented on the screen can be intuitively reduced in size by a user.

As used herein, a “window” refers to a defined region on a screen for displaying images. The window is typically in the form of a rectangle that can be increased or decreased in size. A window may take up the entire region of the screen or part of the screen.

It is to be noted that embodiments are described below with reference to a computing device that controls or monitors the operation of a robot. The reference to the embodiments related to the operation of the robot is merely examples, and other embodiments may be used for other types of operations such as presenting other types of data not related to the operation of a robot. For example, other embodiments may be related to presenting contact information or initializing communication or surfing the Internet using a mobile computing device (e.g., a smartphone).

### Overview of Robot and Remote Computer

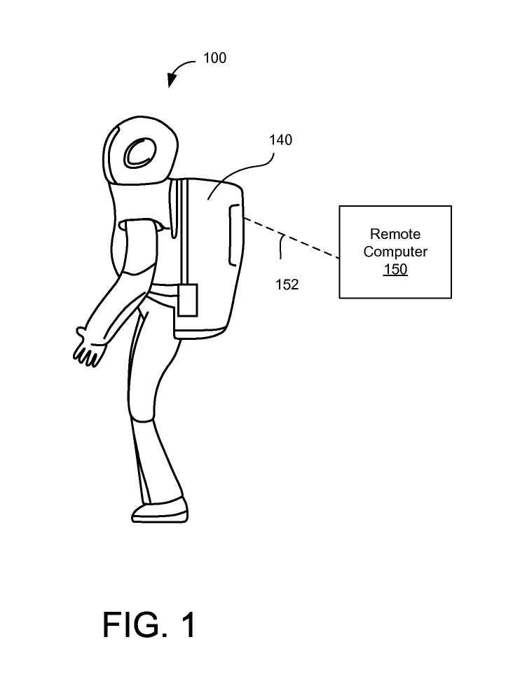

FIG. 1 is a schematic diagram of a robot 100 and a remote computer 150 communicating with the robot 100, according to one embodiment. The robot 100 may include, among other components, a plurality of body parts, actuators for causing relative movements between the body parts, a local computer 140, sensors and output devices (e.g., speaker). The plurality of body parts may include, for example, arms, hands, torso, head, legs and feet. The relative movements of these body parts are caused by actuators such as motors. The sensors may be attached to the body parts to sense the pose of the robot 100 as well as to capture visual images or acoustic signals.

The local computer 140 is hardware, software, firmware or a combination thereof for processing sensor signals and other input commands, generating actuator signals, and communicating with other computing devices. In one embodiment, the local computer 140 communicates with the remote computer 150 via a channel 152 to send data to or receive data from the remote computer 150. The channel 152 may be embodied using wired or wireless technology.

The remote computer 150 is used by a user to gather information about operations of the robot 100 and/or provide instructions to the robot 100. The remote computer 150 may receive raw data or processed data from the robot 100 via the channel 152. The data transmitted over the channel 152 may include, among other data, stream of images captured by one or more cameras installed on the robot 100, sensor signals, coordinates and identities of objects detected around the robot 100, audio signals captured by microphones installed on the robot 100, and instructions to perform certain operations on the robot 100.

Although FIG. 1 illustrates a humanoid form, embodiments may be used in robots of various other configurations. For example, the robot may be an industrial robot with a single arm configuration.

### Example Remote Computer Configuration

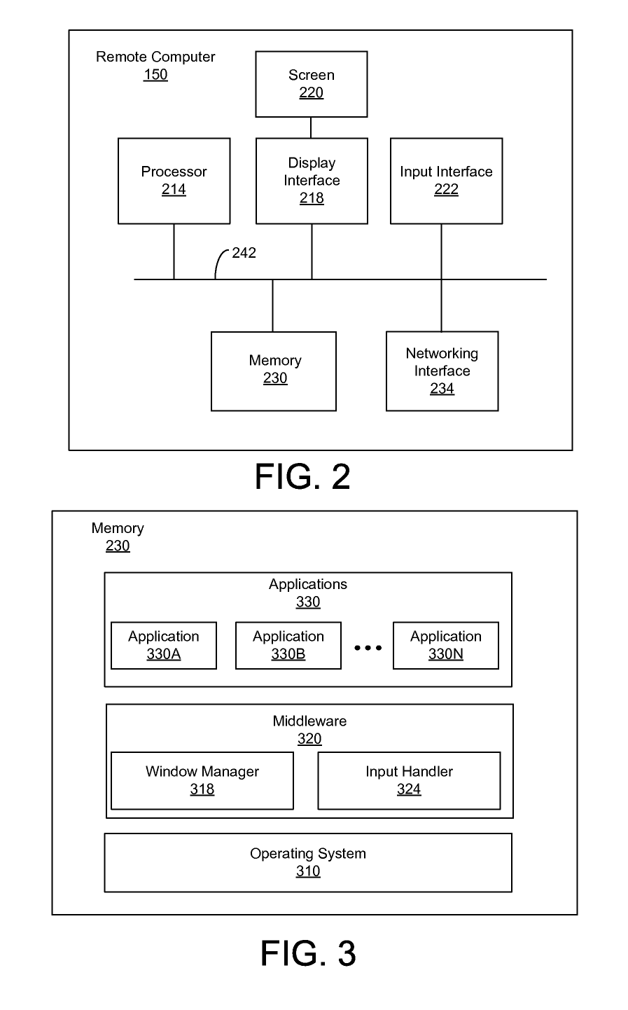

FIG. 2 is a block diagram of the remote computer 150, according to one embodiment. The remote computer 150 may include, among other components, a processor 214, a display interface 218, a screen 220, an input interface 222, memory 230, a networking interface 234 and a bus 242 connecting these components. The remote computer 150 may include other components not illustrated in FIG. 2.

The processor 214 is a hardware component that reads and executes instructions, and outputs processed data as a result of the execution of the instructions. The processor 214 may include more than one processing core to increase the capacity and speed of data processing.

The display interface 218 is a hardware component for generating signals to display images on the screen 220 of the remote computer 150. The display interface 218 generates the signals according to instructions modules on the memory 230. In one embodiment, the display interface 218 is a video card.

The input interface 222 is a component that interfaces with user input devices such as mouse, keyboard and touchpad. The input interface 222 may be embodied as a combination of hardware, software and firmware for recognizing verbal commands issued by a user.

The memory 230 is a computer-readable storage medium storing instruction modules and/or data for performing data processing operations at the processor 214. The details of instructions modules in the memory 230 are described below with reference to FIG. 3.

The networking interface 234 establishes the channel 152 with the robot 100. The networking interface 234 may control transmission of data over the channel 152 using protocols such as IEEE 1394, Wi-Fi, Blootooth, and Universal Serial Bus (USB).

FIG. 3 is a block diagram illustrating software components of the remote computer 150, according to one embodiment. One or more software components illustrated in FIG. 3 may also be embodied as dedicated hardware components or firmware. The memory 230 may store, among other software components, an operating system 310, a middleware 320, and a plurality of application 330A through 330N (hereinafter collectively referred to as “the applications 330”). The memory 230 may include multiple memory devices that can collectively store one or more software components illustrated in FIG. 3.

The operating system 310 manages resources of the remote computer 150 and provides common services for the applications 330. The operating system 310 may include, among others, LINUX, UNIX, MICROSOFT WINDOWS, IOS, MAC OSX and ANDROID.

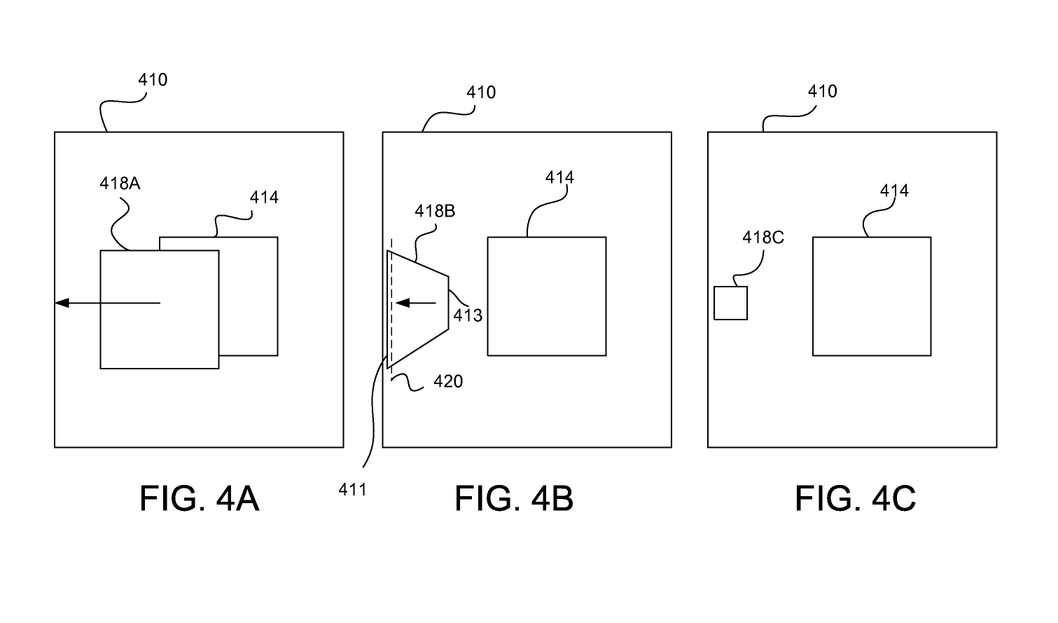

The middleware 320 provides library and functions for some or all of the applications 330. The middleware 320 may include, among other instruction modules, a window manager 318 and an input handler 324. The window manager 318 manages one or more windows displayed on the screen 220. The window manager 318 provides library and functions that enable the applications 330 to create, move, modify or remove one or more windows on the screen 220. In one embodiment, the window manager 318 enables the windows to be rotated and iconified in response to receiving user inputs, as described below in detail with reference to FIGS. 4A through 4C.

The input handler 324 receives user input from the user interface devices (e.g., mouse, keyboard and touchscreen) via the input interface 222, processes the user input and provides processed signals to the applications 330 and/or the window manager 318 for further operations based on the user input.

Each of the applications 330 communicates data from the robot 100 via the channel 152 and some of these applications 330 render images for display on the screen 220 using the window manager 318. The applications 330 may also perform computing operations (e.g., trajectory planning) separate from or in conjunction with the local computer 140. The applications 330 may use the libraries and functions available from the middleware 320 such as the window manager 318 and the input handler 324 to perform their operations.

Example applications 330 include the following: (i) a 3D scene geometry management application for loading geometric models and creating instances of geometric models based on events detected at the sensors of the robot 100, (ii) a videostream application for storing and/or displaying videostream from a camera mounted on the robot or stored in a file, (iii) a panoramic attention application for mapping objects to coordinates around the robot 100 and creating a panoramic display including the mapped objects, (iv) an instruction application for sending high level commands to the robot 100, (v) a plotting application for plotting streams of data associated with the operation of the robot 100 and (vi) a logger application that intercepts messages from the middleware 320 and logs the time at which an event associated with the messages occurred.

In one embodiment, the middleware 320 provides functions and libraries for reusable and extensible set of primitives that enable applications 330 to drawing images on the screen 220. By using the primitives in the middleware 320, various applications 330 can be programmed easily into a compact form. The primitives may also be used as a basis for extending functionality of the applications 330 through dynamic plug-ins. The use of dynamic plug-ins reduces the need to re-compile or modify existing applications 330.

### Fold-Away Window

FIGS. 4A through 4C are diagrams illustrating the transition of a fold-away window 418A on a screen 410 responsive to receiving a user input moving the window 418A to the left edge of the screen 410, according to one embodiment. In order to alleviate cluttering of the windows on the screen 410, a user may decide to reduce the size of a window. The window manager 318 provides a way of rotating the window or iconifying the window in an intuitive manner.

FIG. 4A illustrates the screen 410 where two windows 418A and 414 are displayed in an overlapping manner. As the user provides input (e.g., mouse input selecting the window 418A and dragging the mouse in the left direction) to move the window 418A in the left direction (shown by an arrow) to clear the screen 410 for display of the window 414, the window 418A moves toward the left edge of the screen 410 in a flat state. A flat state refers to the state of the window that is not rotated or iconified.

After reaching the left edge or a region within a certain distance from the left edge, the window 418B (corresponding to the window 418A) is rotated about an axis 420 as user input (e.g., dragging of the mouse in the left direction) in the direction of the arrow of FIG. 4B is received. That is, a virtual plane for projecting the window 418A is rotated about the axis 420, giving three-dimensional perception that the virtual plane and the window 418B is facing towards the right-front side of the screen 410. By rotating the window 418B, the window 414B takes up less space in the screen 410 and is less likely to obstruct the window 414. While the window 418B remains rotated with where the window 418B facing the right-front side of the screen 410, images may continue to be displayed on the window 418B. Moreover, other user interface elements (e.g., icons, controls and menus) of the window 418B remain operable in the slated position, allowing the user to take actions needed without having to expand the window 418B.

In one embodiment, an edge of the window 418B maintains its position while the window 418B is rotated. In the example of FIG. 4B, the left edge 411 of the window 418B remains in the same state while the right edge 413 of the window 418B moves progressively to the left, reducing the overall size of the window 418B with the rotation of the window 418B. The user may leave the window 418B in such a rotated position to view relevant data from the window 418B while focusing on images displayed on the window 414.

Alternatively, the user may further reduce the window 418B into an icon 418C by continuing to provide the same user input (e.g., dragging the mouse in the left direction) after the window 418B is rotated along the axis 420 beyond a certain angle (e.g., 45 degrees). In one embodiment, the angle at which the window 418B iconifies depends on the configuration of the user interface elements in the window 418B. If the size of the user interface elements in the window 418B is small, the window 418B may be iconified even when the window 418B is rotated for a small angle. In contrast, if the size of the user interface elements in the window 418B is large, the window 418B may be iconfied when the window 418B is rotated to a larger angle since the user may operate on the user interface elements at a large rotation angle. By iconifying the window, more space becomes available to display information from other windows or user interface elements.

In one embodiment, the icon 418C can be enlarged into the rotated window 418B or a flat window 418A by providing predetermined user input (e.g., double-clicking of the icon 418C). Two or more icons 418C can also be tiled on the screen 410 to facilitate the user to find and enlarge the relevant icons into windows.

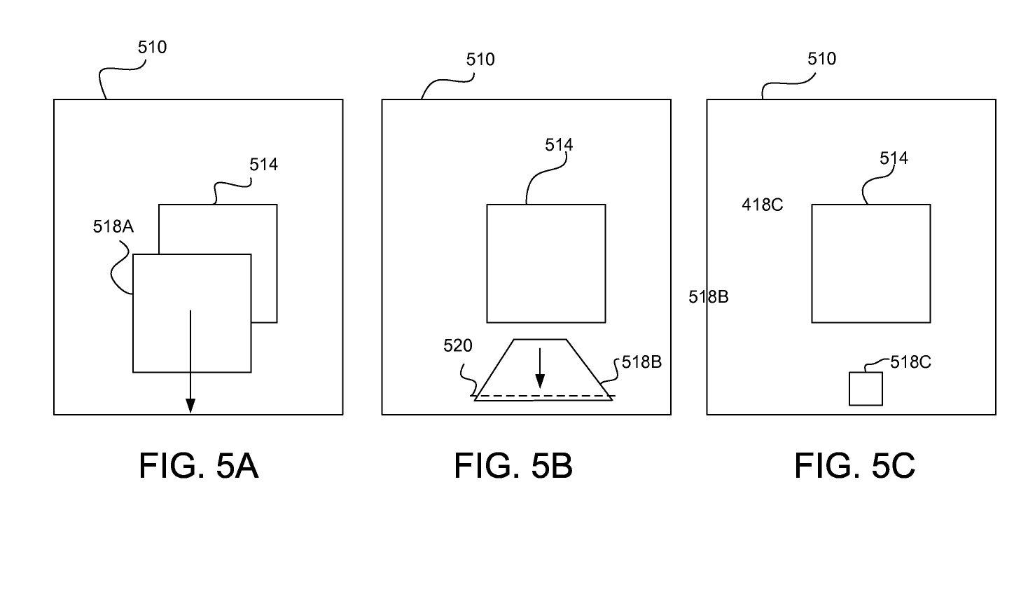

FIGS. 5A through 5C are diagrams illustrating the transition of a fold-away window 518A on a screen responsive to receiving a user input moving the window to the bottom edge of the screen 510, according to one embodiment.

As the user provides input to move the window 518A in a downward direction (shown by an arrow), the window 518A moves toward the bottom edge of the screen 510 in a flat state. After reaching the bottom edge or a point near the edge, the window 518B (corresponding to the window 518A) is rotated about an axis 520 as user input (e.g., dragging of the mouse in the bottom direction) is received from the user via the input handler 324.

The window 518B may be reduced into an icon 518C by continuing to provide the same user input (e.g., dragging the mouse in the bottom direction) after the window 518B is rotated along the axis 520 beyond a certain angle (e.g., 45 degrees).

Although FIGS. 4A through 5C illustrate the rotation of the window 418B relative to a vertical axis 420 or a horizontal axis 520 after being moved to the left or bottom edge of the screen, the same window may be rotated related to a vertical axis or a horizontal axis after the window 418B is moved to an upper edge or right edge of the screen.

The user input causing the rotation of the window or iconification of the window may be different based on the type of input devices used to operate the remote computer 150. When a pointing device such as a mouse is used, clicking of the window followed by a translational (i.e., dragging) motion may cause the window to move to an edge of the screen followed by the rotation of the window and iconification of the window. Alternatively, a first double-clicking of the window may cause the window to rotate about the axis and a second double-clicking of the same window may cause iconification of the window. In touch screens, the scrolling action on the window may cause the window to move to an edge followed by rotation and iconification of the window.

In one embodiment, one or more of the windows may be semi-transparent in its flat state or in a rotated position. The semi-transparent windows may enable the users to view the images in other windows or screen that is obstructed by the semi-transparent window while also enabling the user to view the data displayed on the semi-transparent window. In one embodiment, user input (e.g., scrolling of a mouse wheel) may modify the transparency of the selected window.

### Method of Transitioning Window Displayed on Screen

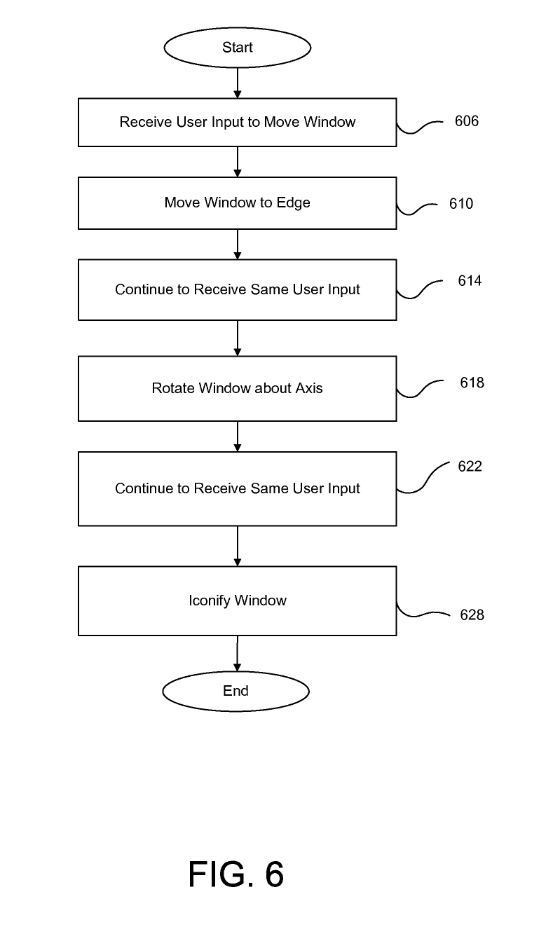

FIG. 6 is a flowchart illustrating a process of reducing the size of a window, according to one embodiment. The remote computer 150 receives 606 user input via a user input device to make translational movement of the window.

As a result of the translational movement, the window moves 610 to an edge of the screen 410 (e.g., the left edge of the screen 410 as shown in FIG. 4B). The remote computer 150 continues 614 to receive the same user input after the window reaches the edge of the screen 410. In response, the window is rotated 618 about an axis (e.g., a vertical axis 420). By rotating the window, other windows on the screen 410 may become unobstructed by the rotated window and may become visible to the user.

If the remote computer 150 continues 622 to receive the same user input after the window is rotated to a certain angle, the window is iconified 628. The iconified window takes up less space on the screen 410 and makes the remaining space available for other windows or user interface elements.

Although above embodiments were described with reference to controlling or displaying information of a robot, different embodiments may be used for displaying data not associated with the operation of the robot. For example, fold-away windows may be used for displaying images associated with other applications such as web browsers, word processors and spreadsheets.

Although several embodiments are described above, various modifications can be made within the scope of the present disclosure. Accordingly, the disclosure of the present invention is intended to be illustrative, but not limiting, of the scope of the invention, which is set forth in the following claims.

What is claimed is:

1. A computer-implemented method of displaying data on a screen, comprising:
displaying data within an area of the screen defined by a window;
moving the window to a predefined region of the screen responsive to receiving first user input; and
displaying rotation of the window about an axis responsive to receiving second user input after the window reaches the predefined region of the screen, wherein a size of the area of the screen displaying the window is reduced by the rotation of the window.

2. The method of claim 1, further comprising reducing the window into an icon responsive to receiving third user input after the window is rotated to a predetermined angle.

3. The method of claim 2, wherein the first user input, the second user input and the third user input are caused by dragging a user input device in a same direction.

4. The method of claim 1, wherein the predefined region of the screen comprises edges of the screen.

5. The method of claim 1, further comprising:
executing a first application to generate first images including the data for display in the area of the screen defined by the window;
executing a second application to generate second images; and
displaying the second images on another area of the screen defined by another window.

6. The method of claim 5, wherein the first and second applications are associated with operation of a robot.

7. The method of claim 6, wherein the first application is one of (i) a scene geometry management application for loading or creating geometric models, (ii) a videostream application for storing or displaying video stream captured by a camera mounted on the robot or stored in a file, (iii) a panoramic attention application for mapping objects to coordinates around the robot and creating a panoramic display relative to the robot, (iv) an instruction application for sending commands to the robot, (v) a plotting application for plotting streams of data associated with the operation of the robot and (vi) a logger application for intercepting messages and logging time of event associated with the intercepted messages.

8. The method of claim 5, wherein the first images or the second images are semi-transparent.

9. The method of claim 5, wherein the first application and the second application share primitives in a middleware.

10. A computing device comprising:
an application configured to process data; and
a window manager associated with the application and configured to:
display images generated by the application within an area of a screen defined by a window;
move the window to a predefined region of the screen responsive to receiving first user input; and
display rotation of the window about an axis responsive to receiving second user input after the window reaches the predefined region of the screen, wherein a size of the area of the screen displaying the window is reduced by the rotation of the window.

11. The computing device of claim 10, further comprising an input handler for processing user input to generate a processed user input signal, the processed user input signal provided to the application or the window manager to move or rotate the window.

12. The computing device of claim 10, wherein the window manager is further configured to reduce the window into an icon responsive to receiving third user input after the window is rotated to a predetermined angle.

13. The computing device of claim 12, wherein the first user input, the second user input and the third user input are caused by dragging a user input device in a same direction.

14. The computing device of claim 10, wherein the predefined region of the screen comprises edges of the screen.

15. The computing device of claim 10, wherein the application is associated with operation of a robot, and further comprising at least another application configured to display another set of images associated with the operation of the robot in another area of the screen defined by another window.

16. The computing device of claim 15, wherein the application and the other application share primitives in a middleware.

17. The computing device of claim 15, wherein the application is one of (i) a scene geometry management application for loading or creating geometric models, (ii) a videostream application for storing or displaying video stream captured by a camera mounted on the robot or stored in a file, (iii) a panoramic attention application for mapping objects to coordinates around the robot and creating a panoramic display relative to the robot, (iv) an instruction application for sending commands to the robot, (v) a plotting application for plotting streams of data associated with the operation of the robot and (vi) a logger application for intercepting messages and logging time of event associated with the intercepted messages.

18. A non-transitory computer readable storage medium structured to store instructions, when executed, cause a processor to:
display data within an area of the screen defined by a window;
move the window to a predefined region of the screen responsive to receiving first user input; and
display rotation of the window about an axis responsive to receiving second user input after the window reaches the predefined region of the screen, wherein a size of the area of the screen displaying the window is reduced by the rotation of the window.

19. The computer-readable storage medium of claim 18, further comprising instruction to reduce the window into an icon responsive to receiving third user input after the window is rotated to a predetermined angle.

20. The computer-readable storage medium of claim 19, wherein the first user input, the second user input and the third user input are caused by dragging a user input device in a same direction.

21. The computer-readable storage medium of claim 18, wherein the predefined region of the screen comprises edges of the screen.
